(19) United States
(12) Patent Application Publication
(10) Pub. No.: US 2023/0211189 A1
(43) Pub. Date: Jul. 6, 2023

(54) VENTILATION DEVICE FOR A FILTERING MASK

(71) Applicant: POLITECNICO DI MILANO, Milano (IT)

(72) Inventors: Ewoud Thomas Johannes WESTERDUIN, Milano (IT); Venanzio ARQUILLA, Milano (IT)

(21) Appl. No.: 17/997,089

(22) PCT Filed: Apr. 28, 2021
(86) PCT No.: PCT/IB2021/053524

§ 371 Date: Oct. 25, 2022

(30) Foreign Application Priority Data
Apr. 29, 2020 (IT) 102020000009337

(51) Int. Cl. A62B 18/00

(52) U.S. Cl. CPC A62B 18/006

(57) ABSTRACT

A ventilation device is disclosed for a filter mask engageable with the outer face of the cup of the filter mask. The device comprises: an inlet port which removably engages an opening of the cup of the mask; an outlet port in fluid communication with the inlet port; an exhalation valve arranged between the inlet port and the outlet port; an extraction fan arranged between the inlet port and the exhalation valve; a sensor arranged at the inlet port to detect the value of a physical quantity; a command and control unit in signal communication with the sensor and with the extraction fan. The command and control unit activates the extraction fan when the value of the physical quantity detected by the sensor exceeds a predefined threshold value.

### TECHNICAL FIELD

The present invention relates to a ventilation device for a sealed filtering mask, such as for example an individual protection device for urban, medical and industrial use. The present invention also relates to a method for controlling the ventilation device. Furthermore, the present invention relates to a ventilation system comprising such a ventilation device.

### BACKGROUND ART

It is known in the art to provide a sealed filtering mask comprising a filter cup which allows particles to be filtered, such as pollutants and microorganisms, thereby ensuring the inhalation of air with a better quality.

It is also known to provide filtering masks provided with an exhalation valve engaged with an opening of the filtering cup. The exhalation valve is configured to allow air to escape from the filter cup of the mask during exhalation, when a predefined pressure value is exceeded. This facilitates a better air exchange in the inner volume defined by the cup.

It is also known to provide a ventilation system, which is also engaged with the opening of the mask's cup. The ventilation system may be switched on by the user to extract air continuously from the cup of the mask, so as to guarantee an exchange of air by the expulsion of exhausted air from the inner volume defined by the cup of the mask.

### SUMMARY OF THE INVENTION

In the prior art, the exhalation valve does not guarantee a correct exchange of air inside the mask, because the operation of the valve does not always coordinate with the respiratory rhythm of the person wearing the mask. This results in pressure imbalance within the filter cup, which hinders proper breathing of the person. Moreover, humidity and temperature conditions may be created inside the mask, which might hinder breathing. However, the pressure could still remain below the threshold value needed for the opening of the exhalation valve. This condition leads to an insufficient exchange of air inside the filter cup.

Moreover, the known masks with extraction fan, operating continuously, could cause a vacuum condition within the filter cup. This could hinder the normal breathing of the person wearing the mask. Moreover, the fan is not capable of avoiding possible opposite airflows from the outside toward the inside of the filter cup. Such airflows, although minimal, pass through the fan avoiding the filtering guaranteed by the cup, thus contaminating the air inhaled by the person. Moreover, in the prior art the extraction fan is positioned inside the filtering cup, in an attempt to limit the phenomenon of contamination due to the inlet of unfiltered air from the outside. This results in a larger footprint and a smaller volume useful for breathing inside the filter cup. Therefore, the same cup of the mask shall have a larger volume in order to accommodate the fan and at the same time ensure the circulation of air inside the mask in use. In this regard, it should be noted that the inner volume of the filter cup is reduced by at least 15-45% when worn by a person. For this reason, it is essential to maintain a useful volume for respiration as large as possible, while maintaining a standard of comfort and encumbrance of the mask for the wearer.

It is an object of the present invention to provide a ventilation device, a method for controlling the ventilation device and a ventilation system incorporating such a device, capable of overcoming at least in part the drawbacks of the prior art.

According to a first aspect of the present invention, a ventilation device is provided for a filtering mask which is removably attachable to the outer face of the filter cup of the filtering mask, comprising:
an inlet port configured to detachably and fluid-tightly engage with an opening of the filter cup of the mask, and an outlet port in fluid communication with the inlet port;
an exhalation valve arranged between the inlet port and the outlet port to allow an airflow from the inlet port to the outlet port when a pressure difference across the exhalation valve exceeds a predefined threshold value;
an extraction fan arranged between the inlet port and the exhalation valve and configured to generate an airflow from the inlet port to the outlet port;
at least one sensor arranged at the inlet port to locally detect the value of a physical quantity; and
a command and control unit in signal communication with the at least one sensor and with the extraction fan and configured to activate the extraction fan when the value of the physical quantity detected by the sensor exceeds a predefined threshold value and to deactivate the extraction fan when the value of the physical quantity detected by the sensor falls below the predefined threshold value.

Preferably, the at least one sensor comprises at least one pressure sensor arranged at the inlet port to detect a local pressure value and the command and control unit is configured to activate the extraction fan when the local pressure value detected by the pressure sensor exceeds a predefined threshold value, and to deactivate the extraction fan when the local pressure value detected by the pressure sensor falls below the predefined threshold value.

Alternatively or in addition, the at least one sensor comprises at least one temperature sensor arranged at the inlet port to detect a local temperature value, and the command and control unit is configured to activate the extraction fan when the local temperature value detected by the temperature sensor exceeds a predefined threshold value and to deactivate the extraction fan when the local temperature value detected by the temperature sensor falls below the predefined threshold value.

Alternatively or in addition, the at least one sensor comprises at least one humidity sensor arranged at the inlet port to detect a local humidity value, and the command and control unit is configured to activate the extraction fan when the local humidity value detected by the humidity sensor exceeds a predefined threshold value and to deactivate the extraction fan when the local humidity value detected by the humidity sensor falls below the predefined threshold value.

Preferably, the ventilation device comprises a radio frequency communication module in signal communication with the command and control unit and configured to communicate with an external device.

Preferably, the ventilation device comprises a button which is manually operable by a user to activate and deactivate the extraction fan.

Preferably, the ventilation device also comprises:
a battery for supplying at least the command and control unit, the extraction fan, the at least one sensor and the radio frequency communication module, if present;
a memory unit in signal communication with the command and control unit;
a casing suitable for containing at least the exhalation valve, the extraction fan, the at least one sensor, the command and control unit, the battery, the memory unit and the radiofrequency communication module, if present.

According to a preferred embodiment, the at least one sensor is positioned substantially at the center of the inlet port.

According to a preferred embodiment, the extraction fan is a centrifugal fan and the exhalation valve comprises a membrane arranged in a curved manner, with the concavity facing the outlet port.

According to a second aspect of the present invention, a ventilation system is provided comprising:
a filtering mask comprising a filter cup provided with an inner face defining an inner volume and intended to be turned towards the face of a person when in use, the filter cup being provided with an outer face opposite to the inner face and intended to be turned outwards when in use; the filter cup being provided with an opening for placing the inner volume in fluid communication with the outside;
a ventilation device as described above, attached removably on the outer face of the filter cup;
an internal fastening element engaged in the opening in correspondence with the inner face of the filter cup and removably attached with the inlet port through the opening to keep the ventilation device detachably fixed on the outer face of the filter cup;

wherein the at least one sensor is configured to detect a value of the physical quantity at the inlet port, which is indicative of the value of the same physical quantity in the inner volume.

Preferably, the inner volume has a maximum value between 100 cm³ and 200 cm³ when the mask is kid-sized, or a maximum value between 200 cm³ and 300 cm³ when the mask is small adult-sized, or a maximum value between 300 cm³ and 450 cm³ when the mask is large adult-sized, or a maximum value between 450 cm³ and 700 cm³ when the mask is of the half-face type, or a maximum value between 700 cm³ and 1000 cm³ when the mask is of the full-face type.

According to a preferred embodiment, the ventilation system also comprises an application suitable for being run by an external device in communication with the ventilation device, the application being configured to receive data from the command and control unit and to display said data on a graphic interface of the external device, the data comprising at least one of: respiratory rate calculated by the command and control unit, speed of the extraction fan, usage time of the ventilation device and operating time of the extraction fan.

Preferably, the application is also configured to send instructions to the command and control unit to remotely control the operation of the extraction fan.

According to a third aspect of the present invention, a method of controlling a ventilation device as described above is provided, comprising the steps of:
detecting local pressure values at predetermined time intervals using at least one pressure sensor;
calculating a respiratory frequency value by processing the pressure values detected at predefined time intervals by the at least one pressure sensor, by using a predefined algorithm residing in the command and control unit;
by the command and control unit, controlling the dynamic operation of the extraction fan as a function of the respiratory frequency value calculated at the previous step.

According to a further aspect, a ventilation device is provided for a filtering mask which can be attached onto the outer face of the filter cup of the filtering mask, comprising:
an inlet port configured to engage removably and fluid-tightly with an opening of the filter cup of the mask, and an outlet port in fluid communication with the inlet port;
an exhalation valve arranged between the inlet port and the outlet port to allow an airflow from the inlet port to the outlet port when a pressure difference across the exhalation valve exceeds a predefined threshold value;
an extraction fan arranged between the inlet port and the exhalation valve and configured to generate an airflow from the inlet port to the outlet port;
at least one pressure sensor arranged at the inlet port to detect local pressure values;
a command and control unit in signal communication with the sensor and with the extraction fan and configured to calculate a respiratory frequency value by processing the pressure values detected by the at least one pressure sensor, and to control dynamically the operation of the extraction fan as a function of the calculated respiratory frequency value.

Advantageously, the ventilation device can also be applied to the filtering masks available on the market, in order to optimize their operation.

Advantageously, the ventilation device according to embodiments of the present invention is capable of ensuring a better exchange of air during use.

Advantageously, the ventilation device according to embodiments of the present invention is capable of ensuring a better quality of the air inhaled by the person wearing the filtering mask on which it is applied.

Advantageously, the ventilation device according to embodiments of the present invention is capable of regulating the extraction of air as a function of the respiratory rhythm and the environmental conditions inside the filter cup of the mask.

Advantageously, the method according to embodiments of the present invention allows to control the operation of the device dynamically, in order to guarantee an optimal air exchange during the use of the mask.

Advantageously, the ventilation system according to embodiments of the present invention is capable of ensuring optimum breathing condition even during sports activities, without renouncing a correct filtering of the inspired air.

### BRIEF DESCRIPTION OF THE DRAWINGS

The features and advantages of the present invention will become apparent from the following detailed description of possible embodiments, illustrated by way of non-limiting examples with reference to the attached drawings, in which:

FIGS. 1 and 1a show a ventilation system and a ventilation device, according to a first and second embodiment of the present invention;

FIGS. 2 and 2a show the ventilation systems and the ventilation devices of FIGS. 1 and 1a, respectively, during use;

FIGS. 3 and 3a show the ventilation systems of FIGS. 1 and 1a in a disassembled configuration in which the ventilation device is released from the other components of the system;

FIGS. 4 and 4a show the ventilation systems of FIGS. 1 and 1a in a mounting configuration in which the ventilation device is coupled by the other components of the system;

FIG. 5 is a rear view of the ventilation system of FIG. 1a;

FIG. 6 is a front view of the ventilation system of FIG. 1a, in which the back shell of the casing of the ventilation device has been removed;

FIGS. 7a and 7b are prospect views showing in further detail the inner structure of the ventilation device comprised in the ventilation systems of FIGS. 1 and 1a;

FIG. 8 is a block diagram of the ventilation system of FIGS. 1 and 1a, according to an embodiment of the present invention;

FIGS. 9 and 10 are flow charts of the operation of the ventilation system in automatic mode and in manual mode, according to an embodiment of the present invention;

FIGS. 11 and 12 are flow charts of the operation of the ventilation system of FIGS. 1 and 1a, according to an embodiment of the present invention; and

FIGS. 13 and 14 show two exemplary screens of the application according to embodiments of the present invention.

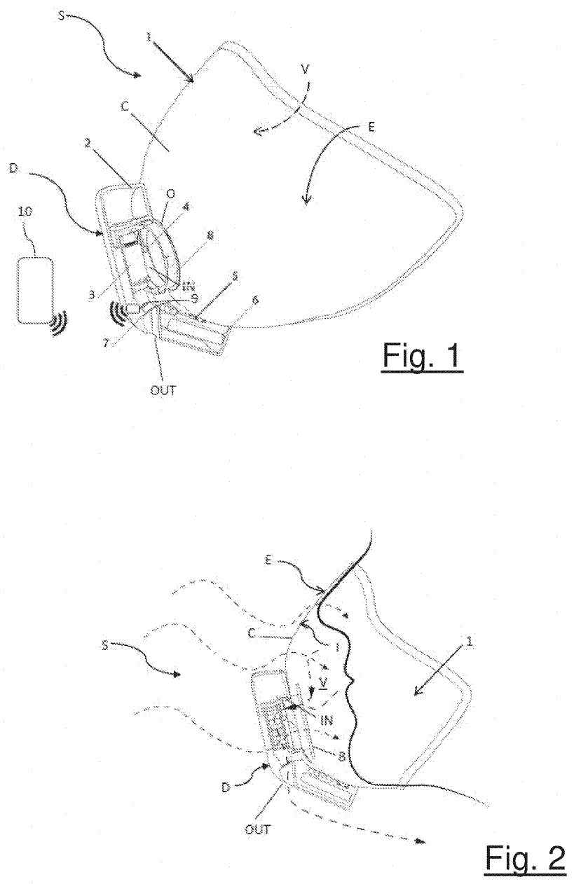

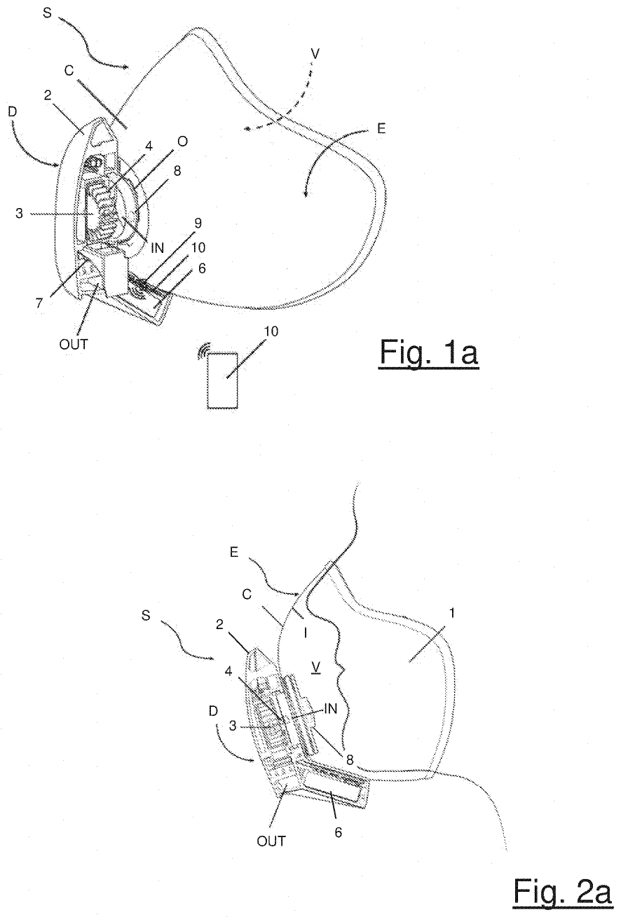

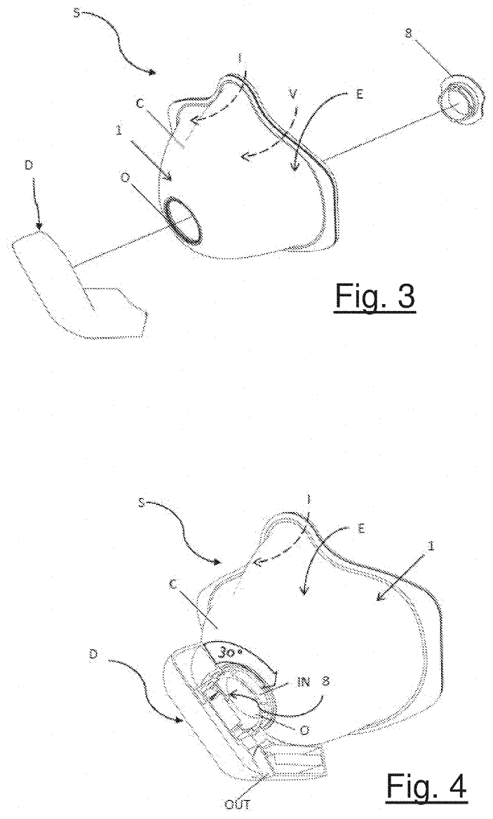

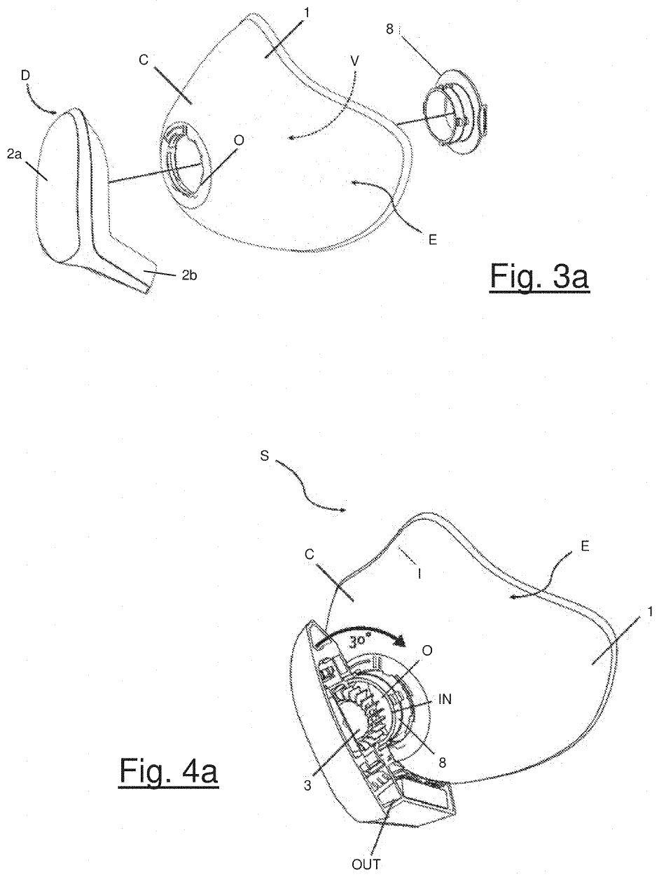

The device and the ventilation system illustrated in the accompanying figures are to be understood as being schematically represented, not necessarily on scale and not necessarily with the represented proportions between the various constituent elements.

### DETAILED DESCRIPTION OF EMBODIMENTS OF THE INVENTION

The present invention relates to a ventilation device D for a filtering mask, illustrated in the accompanying drawings. The ventilation device D may be applied to a filtering mask 1, such as a commercially available mask, of the type for industrial, urban, sports, medical and military use. Examples of known masks are of the type with filter cups, folding cups, half masks, full face masks etc. A mask 1 of known type is provided with a filter cup C having an outer face and an opposite inner face I. The inner face I is intended to face, during use, the face of the user wearing the mask 1. The outer face E is instead intended to face outwardly when the mask 1 is in use. The mask 1 comprises an opening O formed in the filter cup C, which during use places in fluid communication the inner volume V defined by the inner face I of the filter cup C with the outer environment. Moreover, the mask 1 may typically comprise ties, elastic straps or other means which allow to stably and comfortably fix the mask 1 to the face of the wearer.

Within the scope of the present invention, for the sake of brevity, reference is made to the inner volume V as the volume defined by the inner face I of the filter cup C. The inner volume V may be calculated by CAD from 3D models representative of the shape of the filter cup C of the mask 1. However, it should be noted that this volume is calculated, for uniformity of evaluation, by considering the filter cup C in its shape before use by a user. As noted above, indeed the inner volume V is reduced from 15% to 45% during use, i.e. when the mask 1 is worn by a user (FIGS. 2 and 2a). This is due to the fact that the inner volume V, in use, is defined between the inner face I of the filter cup C and the face of the user closing the aperture of the filter cup C. Moreover, the mask itself could undergo deformations to fit the profile of the face. Therefore, for the sake of simplicity of illustration, the inner volume V is calculated taking into account the volume defined by the inner face I of the filter cup C alone, considering the presence of an ideal and uniform part to close the opening of the filter cup C.

The ventilation device D is configured to be engaged, preferably removably, on the outer face E of the filter cup C of a filtering mask 1. The ventilation device D comprises an inlet port IN configured to removably and fluid-tightly engage the opening O of the filter cup C of the mask 1.

The ventilation device D also comprises an outlet port OUT in fluid communication with the inlet port IN. According to the embodiment shown in the drawings, the outlie port OUT is facing downwards. This way, advantageously, the exhaled air is exhausted downwards, thereby preventing e.g. the fogging of glasses or visor which the user might wear.

The ventilation device D comprises an exhalation valve 7 arranged between the inlet port IN and the outlet port OUT, to allow the airflow from the inlet port IN to the outlet port OUT when the pressure difference across the exhalation valve 7 exceeds a predefined threshold value. The exhalation valve 7 may comprise a membrane valve. The membrane valve may be made of a silicone material.

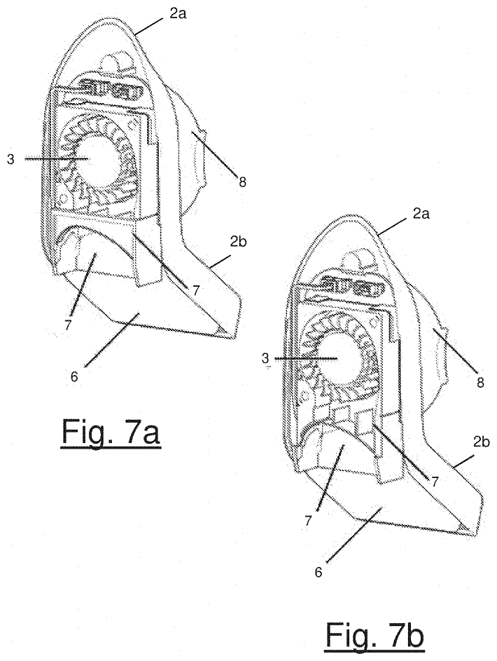

According to an advantageous embodiment, as shown e.g. in FIGS. 7a and 7b, the body of the valve 7 defines a curved housing where the membrane is arranged. The membrane arranged in the housing is also curved, with its concavity facing the outlet port OUT.

The ventilation device D further comprises an extraction fan 3 arranged between the inlet port IN and the exhalation valve 7. The extraction fan 3 is configured to generate an airflow from the inlet port IN toward the outlet port OUT. Preferably, the extraction fan 3 comprises a centrifugal fan. The inventors have realized that using a centrifugal fan is advantageous over other types of fan (e.g. axial fans), because the centrifugal fan preserves its efficiency even in the presence of high pressure variations which typically occur within the ventilation device D during the breathing cycle of the user. The inventors have estimated that using a centrifugal fan in combination with the exhalation valve 7 with curved membrane as described above allows reaching a particularly high extraction efficiency.

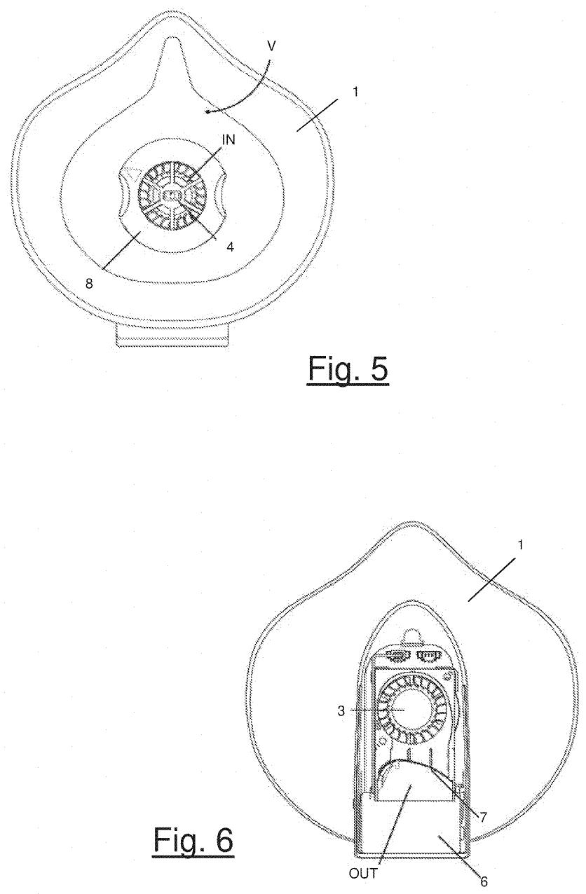

In addition, the ventilation device D comprises at least one sensor 4 arranged at the inlet port IN, to locally detect the value of a physical quantity. In other words, the sensor 4 detects a physical quantity, such as pressure, temperature or humidity, and generates a signal as a function of the detected value. It should be noted that the positioning of the at least one sensor 4 at the inlet port IN allows to detect a value of a physical quantity which corresponds substantially to the value of the same physical quantity in the inner volume V, when the device is in use and therefore applied to a mask 1 worn by a user. Preferably, the sensor 4 is arranged at the inlet port IN to further improve its capability of detecting the physical quantity of interest indicative of the value of this quantity in the inner volume V of the mask 1. More preferably, the sensor 4 is supported substantially at the center of the inlet port IN. For example, the sensor 4 may be arranged at the center of a ring mounted on the inlet port IN of the device D, as shown in FIG. 5. In particular the sensor 4 may be mounted on a central part of the ring which is joined to the edge of the ring by means of rays.

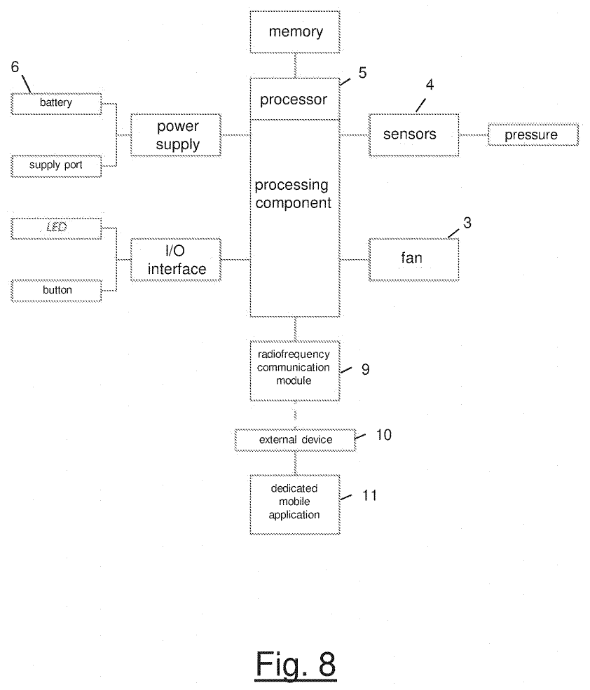

The ventilation device D preferably comprises also a command and control unit 5 in signal communication with the at least one sensor 4 and with the extraction fan 3 (see block diagram in FIG. 8). Preferably, the command and control unit 5 comprises a printed board circuit (PCB).

The command and control unit 5 is configured to receive the signals generated by each sensor 4 and process them to quantify the value of the physical quantity detected. As will be described in greater detail hereinafter, the command and control unit 5 is also configured to activate and/or deactivate the extraction fan 3 on the basis of the value of the physical quantity detected. In particular, the command and control unit 5 is preferably configured to activate the extraction fan 3 when the value of the physical quantity detected by the sensor 4 exceeds a predefined threshold value, and is also configured to deactivate the extraction fan 3 when the value of the physical quantity detected by the sensor 4 falls below the predefined value.

According to a preferred embodiment of the invention, the at least one sensor 4 comprises at least one pressure sensor arranged at the inlet port IN to detect a local pressure value. Preferably, the pressure sensor is a piezoelectric sensor.

According to this embodiment, the command and control unit 5 is configured to activate and/or deactivate the extraction fan 3 on the basis of the local pressure value detected. In particular, according to this embodiment, the command and control unit 5 is configured to activate the extraction fan 3 when the local pressure value detected by the pressure sensor exceeds a predefined threshold value, and to deactivate the extraction fan 3 when the local pressure value detected by the pressure sensor falls below the predefined threshold value. Advantageously, the extraction fan 3 is then activated automatically upon detection of a local pressure greater than the predetermined threshold value when the mask 1 is worn, using the measured data of the pressure sensor.

According to an embodiment of the invention, the command and control unit 5 is configured to calculate a respiratory frequency value of the user wearing the mask 1 as a function of the signals received from the pressure sensor, and to activate/deactivate the extraction fan 3 according to the value of the respiratory frequency detected. Advantageously, in this way the extraction fan 3 is automatically activated upon the detection of a respiratory frequency when the mask 1 is worn, using the measured data of the pressure sensor.

Independently of whether the extraction fan 3 is automatically operated upon detection of a local pressure greater than the threshold value or of a respiratory frequency, in any case, according to an embodiment, the command and control unit 5 is configured to automatically adjust the rotation speed of the extraction fan 3 when the fan 3 is activated, by reducing or increasing the airflow that is extracted, as the user's breathing frequency varies. As the respiratory frequency increases, the extraction speed of the extraction fan 3 increases and, vice versa, as the respiratory frequency decreases, the extraction speed of the fan decreases.

According to a further preferred embodiment of the invention, the at least one sensor 4 comprises at least one temperature sensor arranged at the inlet port IN to detect a local temperature value. The command and control unit 5 is configured to activate and/or deactivate the extraction fan 3 based on the detected temperature value. In particular, the command and control unit 5 is configured to activate the extraction fan 3 when the local temperature value detected by the temperature sensor exceeds a predefined threshold value, and to deactivate the extraction fan 3 when the local temperature value detected by the temperature sensor falls below the predefined threshold value.

According to a preferred embodiment, the at least one sensor 4 comprises at least one humidity sensor arranged in proximity to the inlet port IN to detect a local humidity value. The command and control unit 5 is configured to activate and/or deactivate the extraction fan 3 based on the detected humidity value. In particular, the control unit 5 is configured to activate the extraction fan 3 when the local humidity value detected by the humidity sensor exceeds a predefined threshold value, and to deactivate the extraction fan 3 when the local humidity value detected by the humidity sensor falls below the predefined threshold value.

It should be pointed out that the preferred embodiments described above in connection with pressure, temperature and humidity sensors may be alternative or combined. Preferably, the various types of sensors 4 are provided within a single module. In the case of a combination of two or more types of sensors amongst pressure, temperature and humidity, the command and control unit 5 processes, according to a predefined algorithm, the signals obtained by the different sensors 4 and therefore the overcoming of the respective preset threshold values. For example, the extraction fan 3 may be activated when one of the physical quantities measured exceeds the respective predetermined threshold value. Alternatively, the command and control unit 5 may process according to the predefined algorithm the signal received by the various sensors 4 to generate a reference parameter which also takes into account certain operating conditions; the result of the processing is the parameter to which the threshold for activating the extraction fan 3 is applied. For example, in order to refine the reading of the respiratory frequency, eliminating and filtering out any vibrations in the person's breath given by the speech or by the current effort, the predefined algorithm constantly assigns and updates weights that give value to the data acquired by the pressure sensor 4, generating a new value which depends on the respiration rate; on this value the threshold is applied which determines the actuation of the extraction fan 3. Optionally, the algorithm resident in the command and control unit 5 also takes into account the specific combination of the different physical quantities detected to activate and deactivate the extraction fan 3.

In accordance with a preferred embodiment of the invention, the ventilation device D comprises a radiofrequency communication module 9, such as a Bluetooth communication module, in signal communication with the command and control unit 5 and configured to communicate with an external device 10, such as a smartphone, a smartwatch, a tablet or a PC (see block diagram in FIG. 8).

Preferably, the command and control unit 5 is configured to communicate with the external device 10 via the radiofrequency communication module 9. The external device 10 executes a suitable predefined application 11, which is configured to receive and process the data collected by the command and control unit 5. Preferably, the predefined application 11 may also be used to send instructions to the command and control unit 5 to remotely control operation of the extraction fan 3.

According to an embodiment, the ventilation device D comprises a push-button manually operable by a user to activate and deactivate the extraction fan 3.

Preferably, the ventilation device D comprises one or more LEDs, optionally colored, configured to emit light signals indicative of the operating state of the ventilation device D.

According to an embodiment of the invention, the ventilation device D comprises a battery 6 for supplying at least the command and control unit 5, the extraction fan 3, the at least one sensor 4 and the radiofrequency communication module 9, if present. It should be pointed out that the battery 6 is configured to supply any other component of the ventilation device D that may be present. The battery may be rechargeable.

According to embodiments of the invention, the ventilation device D also comprises a memory unit (see block diagram of FIG. 8), placed in signal communication with the command and control unit 5 to store the data collected by the sensors 4 and data relating to the operation of the extraction fan 3.

According to an embodiment of the present invention, the ventilation device D comprises a casing 2 adapted to contain therein at least the exhalation valve 7, the extraction fan 3, the at least one sensor 4, the command and control unit 5, the battery 6, the memory unit, the radiofrequency communication module 9 if present, and any other possible components of the ventilation device D.

The casing 2 preferably has a substantially “L” shape, comprising a section 2a which in use extends upwards and a section 2b which in use extends backwards (i.e. towards the face of the user wearing the mask 1). The two sections 2a and 2b of the casing 2 form an angle between them, preferably of between 110° and 140°, more preferably between 120° and 130°, for example of 125°, so that the device D follows the convexity of the filter cup C when mounted on the mask 1. The upwardly extending section 2a preferably has a tapered shape, for example an ogive shape. Preferably, the inlet port IN with the at least one sensor 4 and the outlet port OUT are located in correspondence with the section 2a of the casing, while the extraction fan 3 and the exhalation valve 7 are arranged in the volume defined by the section 2a of the casing 2. The command and control unit 5, the battery 6, the memory unit and the radiofrequency communication module 9 (if present) are instead preferably arranged in the volume defined by section 2b of the casing 2.

The casing 2 preferably has an overall height (measured as the height of its projection on a plane substantially parallel to the section 2a) of between 90 mm and 110 mm, more preferably between 95 mm and 100 mm, for example 97 mm. The casing 2 also has a width (measured as the maximum width of its projection in the above plane) between 35 mm and 50 mm, more preferably between 40 mm and 45 mm, for example 43 mm.

The weight of the device D as a whole is preferably between 20 g and 70 g, more preferably between 45 g and 50 g, for example 47 g.

According to an embodiment of the invention, the ventilation device D comprises a supply port (not shown in the accompanying figures), accessible from the outside through the casing 2. The supply port is for example of an USB or micro-USB type, and allows the battery 6 to be recharged and, optionally, it also allows data exchange with the control unit 5. Data exchange via the supply port also allows updating of the predefined algorithm run by the command and control unit 5. Alternatively the battery may be recharged by electromagnetic induction.

According to an embodiment, the ventilation device D comprises insulating means (not shown in the accompanying figures), integrated in the casing and/or inside it, suitable for protecting all the electronic components of the ventilation device D, for example from high temperatures and humidity. In this way, the entire ventilation device D can be released from the mask 1 to be sanitized and/or sterilized according to conventional techniques. Advantageously, the sanitized ventilation device D can be reused by attaching it to a new mask 1 in sterile conditions.

Advantageously, the ventilation device D allows to extract the air from the inner volume V of the mask 1 and to expel it toward the outside, thereby generating a positive microclimate.

Advantageously, the ventilation device D allows to maximize the filtering action of the mask 1 avoiding the introduction, during inhalation, of contaminated air into the mask.

Advantageously, the comfort is improved with the ventilation device D mounted on a mask 1, because it actively extracts the hot and humid air which is normally trapped within the inner volume V of the mask 1, thereby reducing the temperature and internal humidity, and extracting gases generated by the human exhalation such as CO and CO₂ which, wearing a mask for extended periods, they can lead to turning and headaches, as well as loss of concentration.

Advantageously, the ventilation device D does not worsen the comfort of the mask 1 because, being attachable to the outer face E of the filter cup C, it does not interfere with breathing in the inner volume V and does not hinder visibility, having a reduced encumbrance and a conformation that follows the convexity of the filter cup C.

Advantageously, considering the overall airflow, the exhalation valve 7 is positioned after the passage of the airflow generated by the extraction fan 3. Under normal operation of the extraction fan 3, the exhalation valve 7 is kept open by the airflow, but when the user inhales the exhalation valve 7 closes, thereby preventing the entry of contaminated air into the inner volume V. In this way, a proper sealing is ensured, which protects the user and creates a protected positive microclimate, from the inside of the mask up to the exhalation valve 7.

Advantageously, the ventilation device D improves comfort in the use of the mask since it reduces the temperature and humidity inside it, thus obtaining a more comfortable perception on the skin. It also reduces condensation, prevents fogging of any worn glasses, and minimizes the air losses of the mask towards the eyes.

Advantageously, once activated, the extraction fan 3 starts to extract air from the inside of the mask 1, directing it toward the outside, reducing the temperature up to 4° C. and the humidity up to 40%, increasing the comfort for the user wearing the mask 1.

Advantageously, the integrated sensor allows to adapt the operation of the extraction device D with respect to the conditions of use of the mask 1 and to the conditions of the user, adapting automatically to its requirements and to the climatic condition. A climatic condition that can be determined by the radiofrequency connection with the external device 10.

The present invention also relates to a ventilation system S shown in the accompanying drawings.

The ventilation system S comprises a filtering mask 1 comprising a filter cup C provided with an inner face I defining an inner volume V and intended to face the face of a person when in use. The filter cup C is provided with an outer face E, opposite to the inner face I, intended to face outwards when in use. The filter cup C is provided with an opening O for placing the inner volume V in fluid communication with the outside.

The ventilation system S comprises a ventilation device D as described above. The ventilation device D is removably coupled to the outer face E of the filter cup C.

The ventilation system S also comprises an internal fastening element 8 engaged in the opening O at the inner face I of the filter cup C and removably engaged with the inlet port IN through the opening O, to keep the ventilation device D removably engaged on the outer face E of the filter cup C. This allows the mask 1 to be replaced by reusing the ventilation device D several times. Moreover, the same ventilation device D can be used with various types of mask 1 since its operation is dynamic. In fact, the command and control unit 5 regulates the speed of the extraction fan 3 according to the physical quantities detected by the sensors 4. In fact, the at least one sensor 4 is configured to detect a value of the physical quantity at the inlet port IN, which it is indicative of the value of the same physical quantity in the inner volume V. This advantageously allows to have a proper exchange of air inside the filter cup C during the use of the mask 1.

Preferably, the inner fastening component 8 is shaped as a ring which screws on the inlet port IN through the opening O, so as to generate a removable and fluid-tight connection (FIGS. 4 and 4a). Alternatively, the removable and fluid-tight coupling between the inlet port IN and the inner fastening element 8 can be made by bayonet coupling, or by other coupling systems of known type.

According to a preferred embodiment of the ventilation system S, the mask 1 can be of the cup type, of the filter blade type or silicone cup type with filter insert. Preferably, the inner volume V has a maximum value ranging from 100 cm³ to 200 cm³ when the mask 1 is kid-sized, or a maximum value ranging from 200 cm³ to 300 cm³ when the mask 1 is small adult-sized, or a maximum value between 300 cm³ and 450 cm³ when the mask 1 is large adult-sized, or a maximum value between 450 cm³ and 700 cm³ when the mask 1 is of the half-face type, or a maximum value between 700 cm³ and 1000 cm³ when the mask 1 is of the full-face type. Advantageously, thanks to the positioning of the ventilation device D on the outer face E of the filter cup C, it is possible to use a mask of smaller dimensions than the known masks.

According to an embodiment of the ventilation system S, the ventilation device D comprises a radiofrequency communication module 9, in signal communication with the command and control unit 5 and configured to communicate with an external device 10, such as a smartphone, a smartwatch, a tablet or a PC (see the block diagram of FIG. 8). Preferably, the ventilation system S comprises a predefined application 11 executed by the external device 10. The command and control unit 5 is configured to communicate with the external device 10, executing the suitable predefined application 11, configured to receive and process the data collected by the command and control unit 5. Always preferably, the predefined application 11 is configured to send instructions to the command and control unit 5 to remotely control the operation of the extraction fan 3. More preferably, the predefined application 11 has access to the GPS module of the external device 10 to geo-locate the ventilation device D. Even more preferably, the predefined application 11 obtains environmental data concerning the air quality at the geographical position of the ventilation device D. In addition, the predefined application 11 processes the environmental data and data received from the command and control unit 5 to regulate the operation of the extraction fan 3. Moreover, the application 11 may generate results and graphs which can be displayed by the graphical interface of the external device 10, indicating in real time the operation of the ventilation device D and its filtration efficiency, as well as the quality of the air breathed by the user wearing the mask 1.

With reference to FIGS. 2 and 2a, it has to be noted that air passes through the filter by entering the inner volume V through the outer face E of the filter cup C, thereby removing polluting particles or microorganisms such as viruses and bacteria. Meanwhile, the air is of course inhaled by the person. The air contained in the inner volume V exits through the inlet port IN of the ventilation device D when the exhalation valve 7 is open, possibly with the aid of the extraction fan 3 when the latter is in operation. Then, the exhausted air is expelled outside through the outlet port OUT of the ventilation device D, carrying heat and moisture due to breathing.

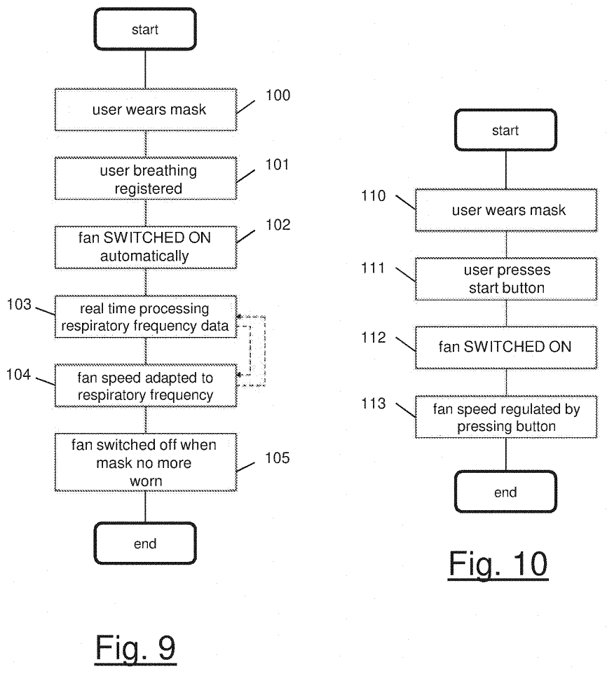

The present invention also relates to a method for controlling the ventilation device D described above. An embodiment of the method will be now described in further detail with reference to the flow chart of FIG. 9.

The user first of all wears the mask 1 having the ventilation device D attached thereto (step 100).

Once the device D is turned on (operation that can be performed by pressing a suitable push-button), the method includes the step of detecting local pressure values at predefined time intervals using the at least one pressure sensor 4 (step 101). The predefined time intervals are preferably comprised between 0.1 sec and 0.3 sec, for example 0.2 sec. It should be noted that device D can be switched on before or after wearing the mask.

The extraction fan 3 is then switched on automatically (step 102). As described above, this can for example occur when it is determined that the local pressure value detected by the at least one pressure sensor 4 has exceeded a predefined threshold value.

The method further comprises the step of processing, by means of a predefined algorithm executed by the command and control unit 5, the pressure values detected at predefined time intervals by the at least one pressure sensor 4, for calculating a respiratory frequency value (step 103).

In addition, the method includes the step of controlling by means of the command and control unit 5 the dynamic operation of the extraction fan 3 as a function of the respiratory frequency value calculated in the previous step (step 104). For example, the command and control unit 5, in which a predefined algorithm resides, increases the rotation speed of the extraction fan 3 when it detects an increase in the respiratory frequency and reduces the rotation speed of the extraction fan 3 when it detects a decrease in respiratory frequency. According to an embodiment, in order to perform this dynamic regulation, the command and control unit 5 may be configured with a discrete set of predefined values of the rotation speed V1, V2, . . . , VN, each value corresponding to a predefined range of the respiratory frequency value. Each calculated respiration frequency value is compared with these ranges and, if it falls within one of them, the rotation speed of the fan 3 is set to the corresponding predefined value. This is particularly useful for ensuring correct breathing, while ensuring a filtering of the inhaled air, when the user wearing the mask 1 is carrying out physical activity.

The fan 3 is then turned off when the sensors 4 detect the termination of respiratory activity as the mask 1 is no longer in use (step 105). As described above, according to an embodiment this can occur when it is determined that the local pressure value detected by the at least one pressure sensor 4 has fallen below the predefined threshold value.

Optionally, the ventilation device D can be configured to also support a manual operating mode, which allows the user to manually adjust the rotation speed of the extraction fan 3.

With reference to the flow chart of FIG. 10, according to this manual mode, the user puts on the mask (step 110) and, once the ventilation device D has been switched on, presses a push-button (step 111) which controls the switching on of the extraction fan 3 (step 112). The user may then control the rotation speed of fan 3 by pressing the same push-button again. To allow this manual regulation, the command and control unit 5 may be configured with a discrete set of predefined rotational speed values (for example 30% Vmax, 60% Vmax, 100% Vmax and 0% Vmax, where Vmax is the maximum rotation speed). Each time the button is pressed, the command and control unit 5 increases the rotation speed of the fan 3 from one predefined value to the next one. The fan 3 can also be stopped manually, by pressing the push-button until the rotation speed returns to the predefined value 0% Vmax.

Clearly, the method of the present invention may also be used for the ventilation system S of the present invention, as will be apparent from the following example of application of the method.

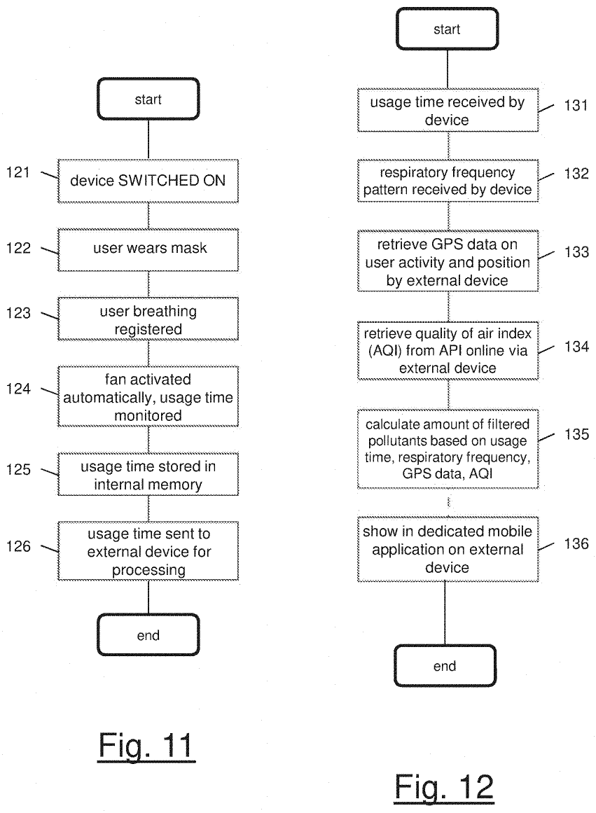

With reference to the flow charts of FIGS. 11 and 12, the interaction between the ventilation device D and the predefined application 11 executed by the external device 10 according to an embodiment of the present invention will be described in further detail.

The method provides for switching on the ventilation device D (step 121), by pressing a suitable push-button.

The user then wears the mask (step 122).

The method then provides for acquiring the respiratory signals by means of the sensors 4 and processing them by means of the command and control unit 5, and finally storing them on the memory unit (step 123).

The method provides for automatically activating the extraction fan 3 by means of the command and control unit 5 when certain conditions are met as regulated by the predefined algorithm executed by the command and control unit 5 (step 124). The method also provides for recording the usage time of the ventilation device D and/or the operating time of the extraction fan 3 by means of the command and control unit 5, and to store these time parameters in the memory unit (step 125).

The method provides for sending, to the external device 10 executing the predefined application 11, the time parameters relating to the usage time of the ventilation device D and to the operating time of the extraction fan 3 (step 126). The method therefore provides for processing the above-mentioned time parameters by means of the predefined application.

The method also provides for detecting the respiration frequency pattern by means of the sensors 4, and for sending this parameter to the external device 10, by means of the command and control unit 5, to be processed by the predefined application 11.

The method provides for adjusting the rotation speed of the extraction fan 3 as a function of the detected respiratory frequency.

The predefined application 11 therefore receives the time data (step 131) and the detected respiratory frequency pattern (step 132).

The method provides for recovering by the predefined application lithe data relating to the geographical position and activity of the person wearing the mask 1 by means of the GPS module of the external device 10 (step 133). For example, in addition to geo-location, it is possible to monitor the displacements and the speed of the person wearing the mask 1 to determine, for example, whether she/he is walking, or stationary, or doing sports, or traveling by car.

Moreover, the method provides for recovering, by means of the predefined application 11, the air quality data at the detected geographical position, by means of the connection to the Internet network of the external device 10 (step 134).

The method provides for processing, by means of the predefined application, data relating to the usage time of the ventilation device D, to the air quality, to the geo-location and to the respiration frequency, to calculate the quantity of pollutants filtered by the mask 1 over a given time interval (step 135).

The method provides for displaying the data relating to the parameters processed on the graphical interface of the external device 10 (step 136).

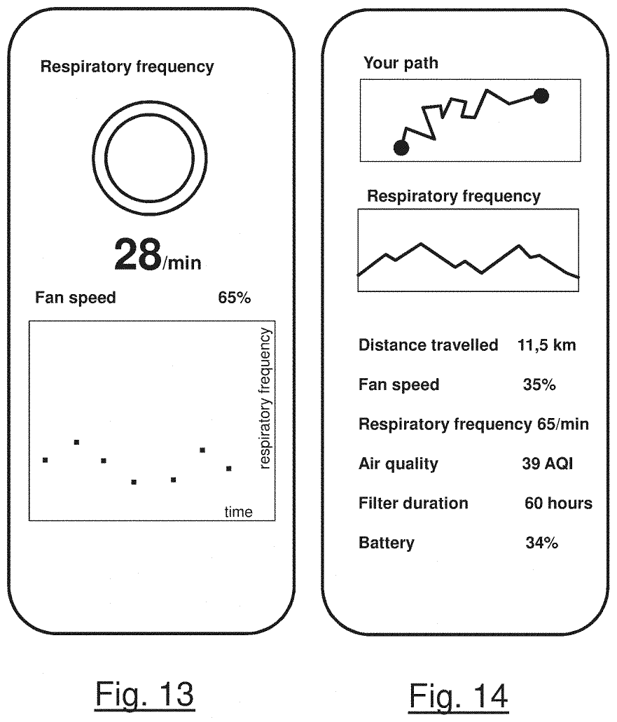

FIGS. 13 and 14 show two exemplary screenshots of the graphic interface of the external device 10, through which the parameters processed by the application 11 are presented.

For example, the screenshot of FIG. 13 shows the instantaneous value of the detected respiratory rate (28/min), the current value of the rotation speed of the fan 3 expressed as a percentage of the maximum rotation speed (65%), and a graph of the pattern of the respiratory frequency over time, during the current session of use of the mask.

The screenshot in FIG. 14, on the other hand, shows a map showing the path that the user is following or has completed, a graph of the respiratory frequency and the numerical value of some parameters relating to the current session of use of the ventilation system S (distance travelled, fan speed and respiratory frequency, air quality and autonomy of the ventilation system, in terms of battery level and/or remaining time before a mask filter change is required).

The method provides for turning off the extraction fan 3 when the sensors 4 detect termination of respiratory activity as the mask 1 is no longer in use.

Optionally, the method may provide for generating a warning by means of the external device 10 which informs the user that the mask 1 must be replaced because the recommended period of use of the filter is lapsed.

1. A ventilation device for a filtering mask removably engageable on the outer face of the filter cup of the filtering mask, comprising:
an inlet port configured to be removably and fluid-tightly engaged to an opening of the filter cup of the mask, and an outlet port in fluid communication with the inlet port;
an expiration valve arranged between the inlet port and the outlet port to allow the airflow from the inlet port towards the outlet port when a pressure difference across the expiration valve exceeds a predefined threshold value;
an extraction fan arranged between the inlet port and the expiration valve and configured to generate an airflow from the inlet port towards the outlet port;
at least one sensor arranged at the inlet port to locally detect the value of a physical quantity; and
a command and control unit in signal communication with the at least one sensor and with the extraction fan and configured to activate the extraction fan when the value of the physical quantity detected by the sensor exceeds a predefined threshold value and to deactivate the extraction fan when the value of the physical quantity detected by the sensor falls below the predefined threshold value.

2. The ventilation device according to claim 1, wherein the at least one sensor comprises:
at least one pressure sensor arranged at the inlet port to detect a local pressure value,
wherein
the command and control unit is configured to activate the extraction fan when the local pressure value detected by the pressure sensor exceeds a predefined threshold value and to deactivate the extraction fan when the local pressure value detected by the pressure sensor falls below the predefined threshold value.

3. The ventilation device according to claim 1, wherein the at least one sensor comprises:
at least one temperature sensor arranged at the inlet port to detect a local temperature value,
wherein
the command and control unit is configured to activate the extraction fan when the local temperature value detected by the temperature sensor exceeds a predefined threshold value and to deactivate the extraction fan when the local temperature value detected by the temperature sensor falls below the predefined threshold value.

4. The ventilation device according to claim 1, wherein the at least one sensor comprises:
at least one humidity sensor arranged at the inlet port to detect a local humidity value,
wherein
the command and control unit is configured to activate the extraction fan when the local humidity value detected by the humidity sensor exceeds a predefined threshold value and to deactivate the extraction fan when the local humidity value detected by the humidity sensor falls below the predefined threshold value.

5. The ventilation device according to claim 1, comprising:
a radiofrequency communication module in signal communication with the command and control unit and configured to communicate with an external device.

6. The ventilation device according to claim 1, comprising:
a push-button manually actuatable by a user to activate and deactivate the extraction fan.

7. The ventilation device according to claim 1, comprising:
a battery for supplying at least the command and control unit, the extraction fan, the at least one sensor and the radiofrequency communication module, if present;
a memory unit in signal communication with the command and control unit;
a casing suitable for containing therein at least the expiration valve, the extraction valve, the at least one sensor, the command and control unit, the battery, the memory unit and the radiofrequency communication module, if present.

8. The ventilation device according to claim 1, wherein said at least one sensor is positioned substantially at the center of the inlet mouth.

9. The ventilation device according to claim 1, wherein the extraction fan is a centrifugal fan and the exhalation valve comprises a membrane arranged in a curved manner, with its concavity facing towards the outlet port.

10. A ventilation system comprising:
a filtering mask comprising a filter cup provided with an inner face defining an inner volume and intended to be directed towards a person's face when in use, the filter cup being provided with an outer face opposite to the inner face and intended to be outwardly directed when in use; the filter cup being provided with an opening to put in fluid communication the inner volume with the outside;
a ventilation device according to claim 1, removably engaged on the outer face of the filter cup;
an inner fixing element in the opening at the inner face of the filter cup and removably engaged with the inlet port through the opening to keep the ventilation device removably engaged on the outer face of the filter cup;
wherein
the at least one sensor is configured to detect a value of the physical quantity at the inlet port, which is indicative of the value of the physical quantity within the inner volume.

11. The ventilation system according to claim 10, wherein
the inner volume has a maximum value comprised between 100 cm³ and 200 cm³ when the mask is kid-sized, or a maximum value between 200 cm³ and 300 cm³ when the face mask is small adult-sized, or a maximum value between 300 cm³ and 450 cm³ when the mask is a large adult-sized, or a maximum value between 450 cm³ and 700 cm³ when the mask is of the half-face type, or a maximum value between 700 cm³ and 1000 cm³ when the mask is of the full-face type.

12. The ventilation system according to claim 10, also comprising an application configured to be executed by an external device in communication with the ventilation device, the application being configured to receive data from the command and control unit and to display said data on a graphic interface of the external device, said data comprising at least one of: respiratory frequency calculated by the command and control unit, speed of the extraction fan, usage time of the ventilation device and operating time of the extraction fan.

13. The ventilation system according to claim 12, wherein the application is also configured to send instructions to the command and control unit to remotely control the operation of the extraction fan.

14. A method for operating a ventilation device according to claim 2, comprising the steps of:
detecting local pressure values at predefined time intervals by the at least a pressure sensor;
calculating a respiratory frequency value by processing, by means of a predefined algorithm executed by the command and control unit, the local pressure values detected at predefined time intervals by the at least a pressure sensor;
controlling by means of the command and control unit the dynamic operation of the extraction fan as a function of the respiratory frequency value calculated in the previous step.

15. A ventilation device for a filtering mask engageable onto the outer face of the filter cup of the filter mask, comprising:
an inlet port configured to be removably and fluid-tightly engaged to an opening of the filter cup of the mask, and an outlet port in fluid communication with the inlet port;
an exhalation valve arranged between the inlet port and the outlet port to allow the airflow from the inlet port towards the outlet port when a pressure difference across the exhalation valve exceeds a predefined threshold value;
an extraction fan arranged between the inlet port and the exhalation valve and configured to generate an airflow from the inlet port towards the outlet port;
at least one pressure sensor arranged at the inlet port to detect local pressure values; and
a command and control unit in signal communication with the sensor and with the extraction fan and configured to calculate a respiratory frequency value by processing the pressure values detected by the at least one pressure sensor and to dynamically control the operation of the extraction fan as a function of the calculated respiratory frequency value.
